(19) United States
(12) Patent Application Publication
(10) Pub. No.: US 2006/0199490 A1
(43) Pub. Date: Sep. 7, 2006

(54) Incubator

(76) Inventors: Masato Honda, Ageo-shi (JP); Toshio Otomo, Kitaadachi-gun (JP); Eiji Koike, Saitama-shi (JP); Kazuo Matsubara, Bunkyo-ku (JP)

Correspondence Address: JONES DAY, 77 WEST WACKER, CHICAGO, IL, 60601-1692, US

(21) Appl. No.: 11/315,961

(22) Filed: Dec. 22, 2005

(30) Foreign Application Priority Data
Jan. 27, 2005 (JP) 2005-19643

(51) Int. Cl. B08B 15/00

(52) U.S. Cl. 454/49

(57) ABSTRACT

In an incubator, in a state in which a door closes a porthole, a packing prevents an air current flowing between walls of a double-wall of a hood from entering the hood through a porthole in the inner wall. Therefore, the air current does not enter the hood through the porthole in the inner wall. In a state in which the door opens the porthole, because the packing separates from the porthole in the inner wall, the air current flows between the porthole in the inner wall and the porthole in the outer wall. Therefore, an air curtain is formed in the porthole. As a result, a suitable environment in the hood is invariably maintained in both of states in which the door closes and opens the porthole.

### BACKGROUND OF THE INVENTION

1. Field of the Invention

The present invention relates to an incubator for accommodating an immature infant or the like in a hood which can realize a suitable environment for the immature infant or the like and for protecting and nursing the accommodated infant.

2. Description of the Related Art

FIGS. 5 to 7 are general views of an incubator according to the first related art to the invention. In this incubator 11, a transparent hood 13 is mounted on a base 12 and a bed 15 on which an accommodated infant 14 is to be laid down is disposed in the hood 13. A bottom face of the hood 13 is provided with an air passage 16, and a controller (not shown) for controlling a temperature, a humidity, an oxygen concentration, and the like of air to suitable values for the accommodated infant 14 and a fan (not shown) for sending an air current 17 under control into the air passage 16 are provided in the base 12.

An access window 18 for treating the accommodated infant 14 in the hood 13 from the outside of the hood 13 is formed in a side of the hood 13 and an access door 21 is mounted to the base 12 to face the access window 18. The access door 21 turns about a rotational shaft (not shown) in a vicinity of a lower end of the door 21 to thereby open and close the access window 18 and is retained by a lever 22 in a state of closing the access window 18. The access door 21 has a double-wall structure including an inner wall 21a and an outer wall 21b and an air passage 23 is formed between the inner wall 21a and the outer wall 21b.

As shown in FIG. 6, when the access window 18 is closed with the access door 21, the air passage 16 and the air passage 23 communicate with each other. Therefore, the air current 17 sent from the fan into the air passage 16 passes successively through the air passage 16 and the air passage 23, is released in a vicinity of a ceiling of the hood 13 to make the environment in the hood 13 suitable for the accommodated infant 14, and then is circulated to the fan again. On the other hand, as shown in FIG. 7, when the access door 21 opens the access window 18, the air current 17 is released from the air passage 16 to a portion where the access door 21 was positioned when the access window 18 was closed. As a result, an air curtain is formed at the access window 18 and air is not likely to be exchanged between the inside and the outside of the hood 13 through the access window 18 during treatment of the accommodated infant 14 through the access window 18.

For treatment of the accommodated infant 14 in the hood 13 from the outside of the hood 13 by only inserting hands of a treating person into the hood 13 without opening the access window 18, portholes 24 are provided to the access door 21 or the like. Because the access door 21 has the double-wall structure, each porthole 24 also has a porthole 24a and a porthole 24b formed respectively in the inner wall 21a and the outer wall 21b of the access door 21. A door 25 is mounted to the access door 21 to face each porthole 24 and the door 25 turns about a rotational shaft 26 at a side portion of the door 25 to thereby open and close the porthole 24. The door 25 is retained by a button 27 in a state of closing the porthole 24. When the button 27 is operated by pressing, the door 25 is released from retaining by the button 27 to open the porthole 24.

Although the portholes 24 and the doors 25 are illustrated only on the access door 21 in FIG. 5, similar portholes and doors may be provided to side faces of the hood 13 other than the access door 21. FIG. 8 shows the porthole 24 and the door 25 on the access door 21 and a portion in the vicinity of them. As shown in FIG. 8, a packing 28 for maintaining airtightness between the air passage 23 and the inside and the outside of the hood 13 at the porthole 24 is mounted to a periphery of the porthole 24. There is also an incubator 11 according to the second related art, in which a packing only maintaining airtightness between the air passage 23 and the outside of the hood 13 at the porthole 24 and not substantially obstructing the air current 17 at the porthole 24 is mounted to the periphery of the porthole 24.

However, in the incubator 11 according to the first related art shown in FIGS. 5 to 8, the packing 28 for maintaining airtightness between the air passage 23 and the inside and the outside of the hood 13 at the porthole 24 is mounted to a periphery of the porthole 24 as described above. Therefore, the air current 17 sent into the air passage 23 flows by a roundabout route without flowing to the portholes 24 and air curtains are not formed in the portholes 24 even when the doors 25 open the portholes 24. As a result, the air is likely to be exchanged between the inside and the outside of the hood 13 through the portholes 24, the suitable environment in the hood 13 is likely to be disturbed by air outside the hood 13, and it is difficult to maintain the suitable environment in the hood 13.

On the other hand, in the incubator 11 according to the second related art in which the packing not substantially obstructing the air current 17 at the porthole 24 is mounted to the periphery of each porthole 24, air curtains are also formed in the portholes 24. Therefore, even when the doors 25 open the portholes 24, air is less likely to be exchanged between the inside and the outside of the hood 13 through the portholes 24 and the suitable environment in the hood 13 is not likely to be disturbed by air outside the hood 13. Incidentally, the air current flowing through the air passages 16, 23 is released from the air passage 23 to the vicinity of the ceiling of the hood 13 to make the environment in the hood 13 suitable for the accommodated infant 14 as described above, and to be more precise, make an environment of a position of the accommodated infant 14 laid on the bed 15 suitable for the accommodated infant 14.

On the other hand, a room in which the incubator 11 is disposed is normally air-conditioned and a temperature of the environment suitable for the accommodated infant 14 is higher than a temperature of the air-conditioned room, in general. Therefore, the air current 17 sent into the air passages 16, 23 is cooled by the time it flows through the air passages 16, 23 and reaches the position of the bed 15. Consequently, a temperature of the air current 17 flowing through the air passages 16 and 23 is still higher than the temperature of the environment suitable for the accommodated infant 14. In the incubator 11 according to the second related art in which the packing not substantially obstructing the air current 17 in each porthole 24 is mounted to the periphery of each porthole 24, even when the doors 25 close the portholes 24, a part of the high-temperature air current 17 flowing through the air passage 23 enters the hood 13 through the porthole 24a in the inner wall 21a of the access door 21.

As a result, depending on a height and an inclination of the bed 15 and the like in the hood 13, a position of the accommodated infant 14 on the bed 15, and the like, a part of the high-temperature air current 17 flowing through the air passage 23 directly flows to the position of the accommodated infant 14 in the hood 13 through the porthole 24a in the inner wall 21a of the access door 21, or an amount itself of the air current 17 entering the hood 13 through the porthole 24a in the inner wall 21a of the access door 21 varies. As a result, in the incubator 11 according to the second related art, it is difficult to maintain the suitable environment in the hood 13 when the porthole 24 is closed with the door 25.

In other words, in the incubators 11 according to the above first and second related arts, it is difficult to invariably maintain the suitable environment in the hood 13 in both of states in which the door 25 closes and opens the porthole 24.

### OBJECT AND SUMMARY OF THE INVENTION

Therefore, it is an object of the present invention to provide an incubator in which a suitable environment in a hood is invariably maintained in both of states in which a door closes and opens a porthole.

In an incubator according to the invention, in a state in which the door closes the porthole, a packing prevents an air current flowing between an inner wall and an outer wall of a double-wall of a hood from entering the hood through a porthole in the inner wall. Therefore, irrespective of a height and an inclination of the bed or the like in the hood, a position of an accommodated infant on the bed, and the like, the air current flowing between the inner wall and the outer wall of the double-wall of the hood does not directly flow to the position of the accommodated infant in the hood through the porthole in the inner wall. As a result, the suitable environment in the hood at the position of the accommodated infant which is especially important is maintained. Moreover, irrespective of the height and the inclination of the bed or the like in the hood, the position of the accommodated infant on the bed, and the like, an amount of the air current entering the hood through the porthole in the inner wall does not vary. As a result, the suitable environment in the hood is not disturbed and the suitable environment in the hood is maintained.

On the other hand, when the door opens the porthole, because the packing is positioned away from the porthole in the inner wall of the double-wall of the hood, the air current between the inner wall and the outer wall of the double-wall of the hood flows in a direction along the inner wall and the outer wall between the porthole in the inner wall and the porthole in the outer wall. Thus, an air curtain is formed in the porthole and air is not likely to be exchanged between the inside and the outside of the hood through the porthole because of this air curtain. As a result, the suitable environment in the hood is not likely to be disturbed by air outside the hood and the suitable environment in the hood is maintained. Therefore, in both of states in which the door closes and opens the porthole, the suitable environment in the hood is invariably maintained.

In a preferred incubator according to the invention, a packing is mounted to the door and separates from and approaches the porthole in the inner wall of the double-wall of the hood as the door opens and closes the porthole. Thus, with the simple structure, the packing prevents the air current from entering the hood through the porthole in the inner wall and separates from the porthole in the inner wall. As a result, a cost of manufacturing the incubator is low.

In a further preferred incubator according to the invention, two-step protruding portions at an outer peripheral portion of the packing separate from and approach the portholes in the inner wall and the outer wall in the double-wall of the hood, respectively, as the door opens and closes the porthole. Thus, with the simple structure, the packing prevents entry of the air current into the hood through the porthole in the inner wall, a leakage of the air current to an outside of the hood through the porthole in the outer wall, and mixture of air outside the hood into the air current and the packing separates from the portholes in the inner wall and the outer wall. As a result, a cost of manufacturing the incubator is low.

### BRIEF DESCRIPTION OF THE DRAWINGS

FIG. 1 is a general perspective view of one embodiment of the present invention.

FIG. 2 shows an essential part of the embodiment of the invention in a state in which a door closes a porthole.

FIG. 3 shows an essential part of the embodiment of the invention in a state in which the door opens the porthole.

FIGS. 4(a) and 4(b) show a state of an air current in a double-wall wherein FIG. 4(a) shows the state in which the door closes the porthole and FIG. 4(b) shows the state in which the door opens the porthole.

FIG. 5 is a general front view of the first related art to the invention.

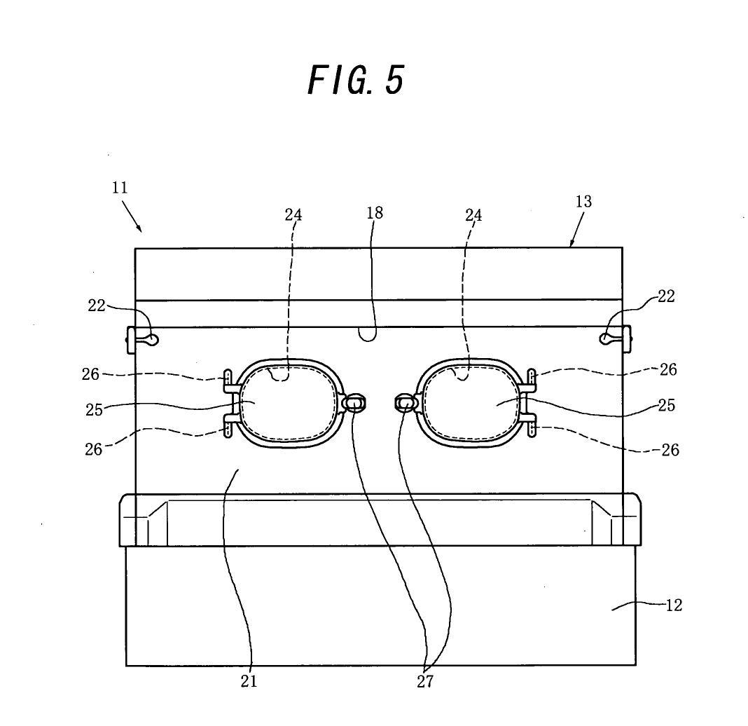

FIG. 6 is a general view of the first related art to the invention and is a sectional view of a state in which an access door closes an access window.

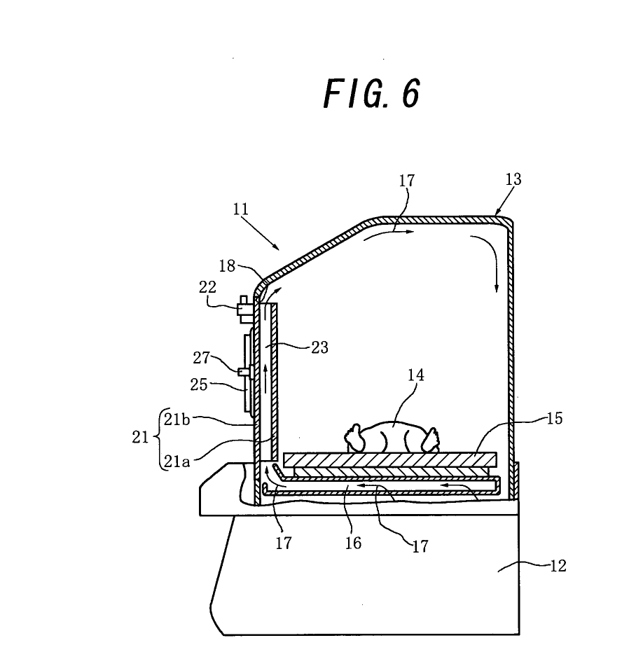

FIG. 7 is a general view of the first related art to the invention and is a sectional view of a state in which the access door opens the access window.

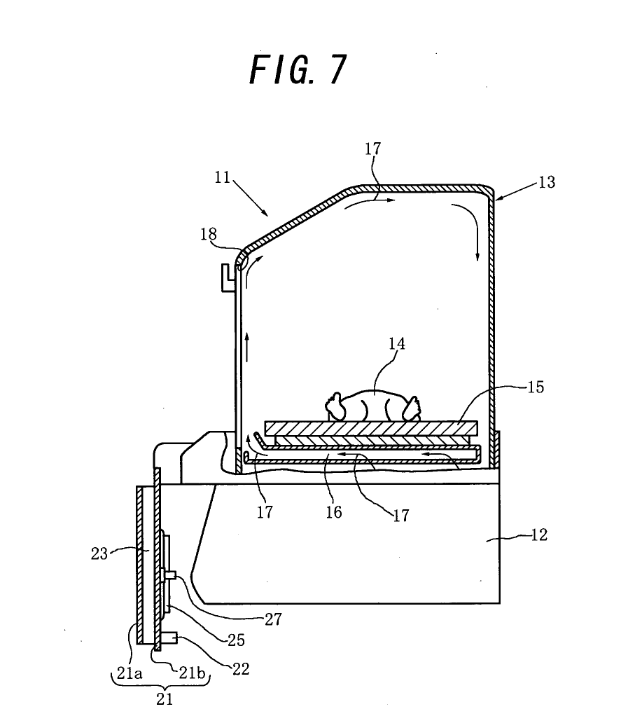

FIG. 8 is a sectional view of an essential part of the first related art to the invention.

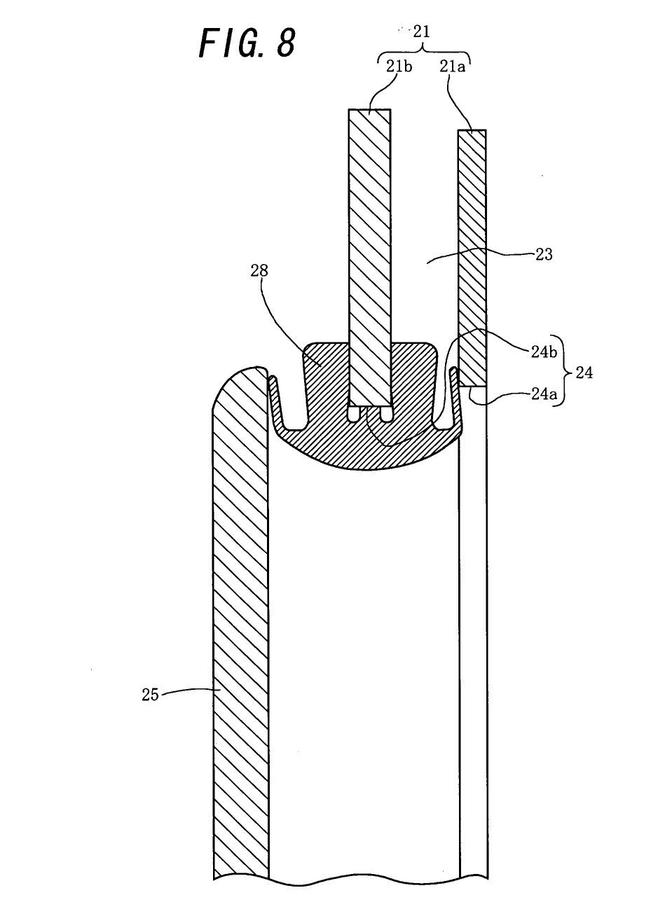

### DETAILED DESCRIPTION OF THE PREFERRED EMBODIMENT

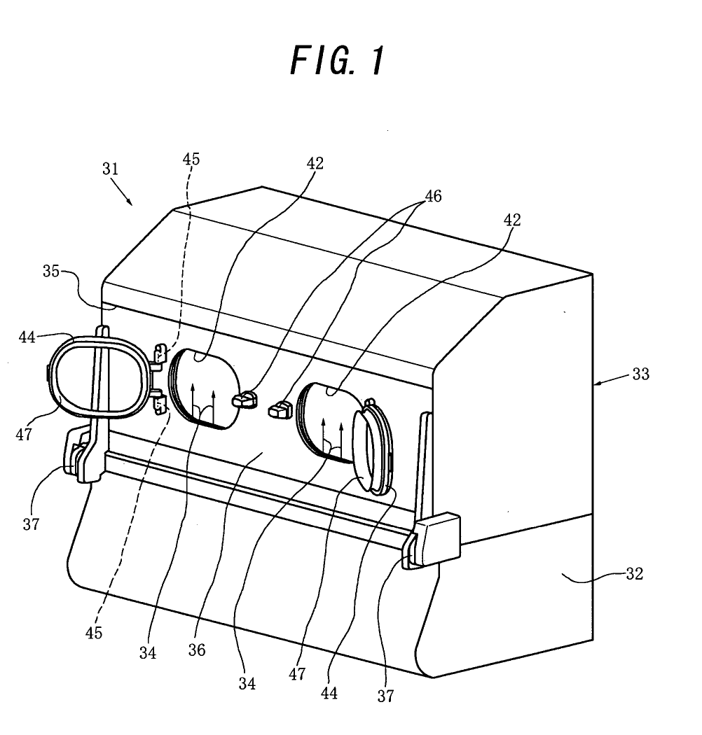

One embodiment of the present invention will be described below by reference to FIGS. 1 to 4. As shown in FIG. 1, in an incubator 31 according to the present embodiment, a transparent hood 33 is mounted on a base 32 and a bed (not shown) on which an accommodated infant (not shown) is to be laid is disposed in the hood 33. A bottom face of the hood 33 is provided with an air passage (not shown), and a controller (not shown) for controlling a temperature, a humidity, an oxygen concentration, and the like of air to suitable values for the accommodated infant and a fan (not shown) for sending an air current 34 under control into the air passage are provided in the base 32.

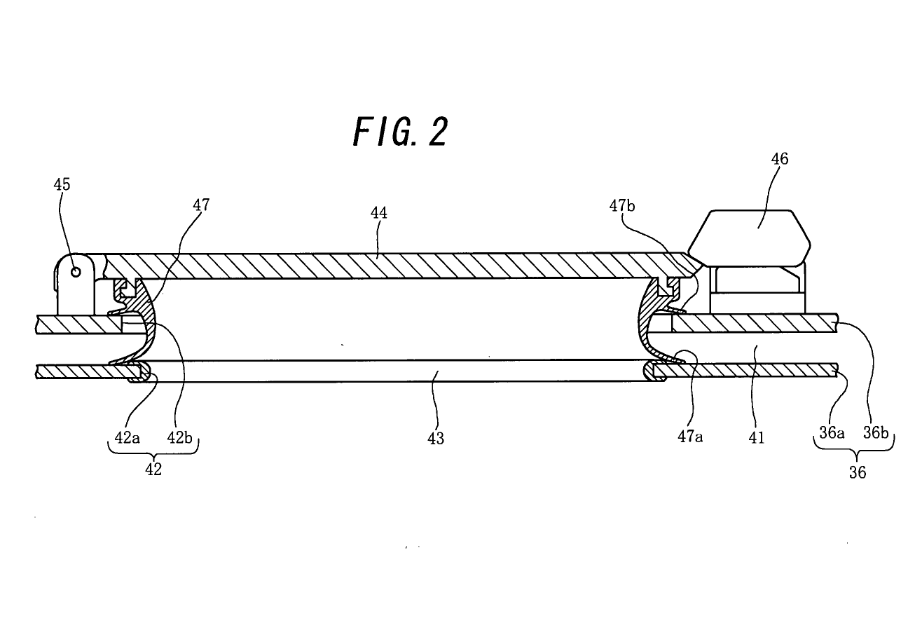

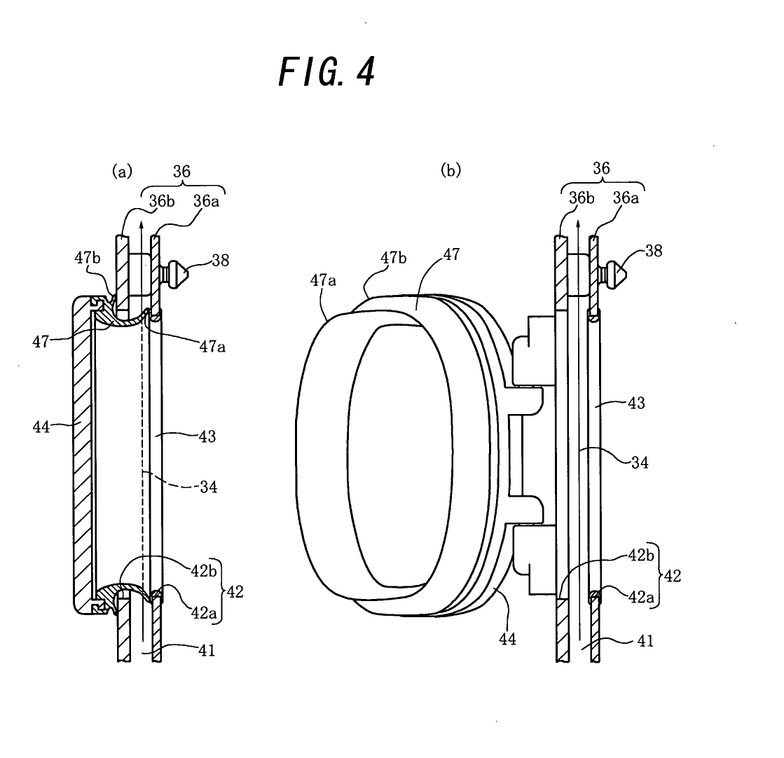

An access window 35 for treating the accommodated infant in the hood 33 from the outside of the hood 33 is formed in a side of the hood 33 and an access door 36 is mounted to the base 32 to face the access window 35. The access door 36 turns about a rotational shaft 37 to thereby open and close the access window 35 and is retained in a state of closing the access window 35 when protruding portions 38 (FIG. 4) in vicinities of upper corner portions on opposite ends of the door 36 are engaged with engaging portions (not shown) of the hood 33. As shown in FIGS. 2 to 4, the access door 36 has a double-wall structure including an inner wall 36a and an outer wall 36b and an air passage 41 is formed between the inner wall 36a and the outer wall 36b.

Also in the incubator 31 according to the embodiments, similarly to the incubator 11 according to the above first related art, when the access window 35 is closed with the access door 36, the air passage in the bottom face of the hood 33 and the air passage 41 communicate with each other. Therefore, the air current 34 sent from the fan into the air passage in the bottom face of the hood 33 passes successively through the air passage and the air passage 41, is released in a vicinity of a ceiling of the hood 33 to make the environment in the hood 33 suitable for the accommodated infant, and then is circulated to the fan again.

When the access door 36 opens the access window 35, the air current 34 is released from the air passage in the bottom face of the hood 33 to a portion where the access door 36 was positioned in the closed state of the access window 35. As a result, an air curtain is formed at the access window 35 and air is not likely to be exchanged between the inside and the outside of the hood 33 through the access window 35 during treatment of the accommodated infant through the access window 35. For treatment of the accommodated infant in the hood 33 from the outside by only inserting hands of a treating person into the hood 33 without opening the access window 35, portholes 42 are provided to the access door 36 or the like. Because the access door 36 has the double-wall structure, each porthole 42 also has a porthole 42a and a porthole 42b formed respectively in the inner wall 36a and the outer wall 36b of the access door 36.

Each porthole 42a in the inner wall 36a of the access door 36 is mounted with a protective ring 43 made of a soft material such as rubber so as to prevent an injury to a hand, a foot, and the like of the accommodated infant resulting from contact. A door 44 is mounted to the access door 36 to face each porthole 42 and the door 44 turns about a rotational shaft 45 at a side portion of the door 44 to thereby open and close the porthole 42. The door 44 is retained by a button 46 in a state of closing the porthole 42. When the button 46 is operated by pressing, the door 44 is released from retaining by the button 46 to open the porthole 42. Although the portholes 42 and the doors 44 are illustrated only on the access door 36 in FIG. 1, similar portholes and doors may be provided to side faces of the hood 33 other than the access door 36.

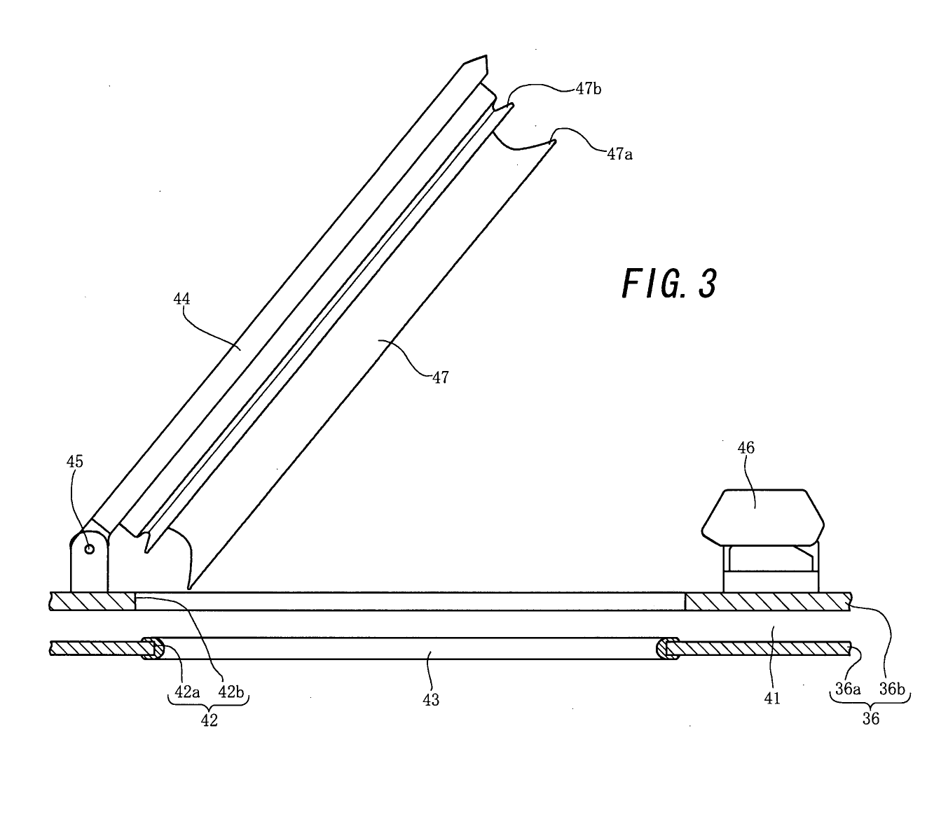

FIGS. 2 and 3 show the porthole 42 and the door 44 on the access door 36 and a portion in the vicinity of them. A packing 47 made of a soft material such as rubber is mounted to a periphery of an inner face of the door 44 and two-step protruding portions 47a and 47b are formed at an outer peripheral portion of the packing 47. As described above, the door 44 turns about the rotational shaft 45 to thereby open and close the porthole 42 and the packing 47 is mounted to the door 44. Therefore, as the door 44 opens and closes the porthole 42, the packing 47 separates from and approaches the porthole 42.

As a result, as shown in FIG. 2, when the porthole 42 is closed with the door 44, the protruding portions 47a and 47b of the packing 47 are in contact with outer faces of the inner wall 36a and the outer wall 36b of the access door 36, respectively, to maintain airtightness between the air passage 41 and the inside and the outside of the hood 33 at the porthole 42. On the other hand, as shown in FIG. 3, when the door 44 opens the porthole 42, the packing 47 is not positioned in the porthole 42.

Therefore, when the porthole 42 is closed with the door 44, as shown in FIG. 4(a), the air current 34 sent into the air passage 41 flows by a roundabout route without flowing to the porthole 42 and the air current 34 flowing through the air passage 41 is prevented by the packing 47 from entering the hood 33 through the porthole 42a in the inner wall 36a of the access door 36. Thus, irrespective of a height and an inclination of the bed or the like in the hood 33, a position of the accommodated infant on the bed, and the like, the air current 34 flowing through the air passage 41 does not directly flow to the position of the accommodated infant in the hood 33 through the porthole 42a in the inner wall 36a of the access door 36. As a result, the suitable environment in the hood 33 at the position of the accommodated infant which is especially important is maintained.

Moreover, irrespective of the height and the inclination of the bed or the like in the hood 33, the position of the accommodated infant on the bed, and the like, an amount of the air current 34 entering the hood 33 through the porthole 42a in the inner wall 36a of the access door 36 does not vary. As a result, the suitable environment in the hood 33 is not disturbed and the suitable environment in the hood 33 is maintained.

On the other hand, when the door 44 opens the porthole 42, because the packing 47 is positioned away from the porthole 42, as shown in FIG. 4(b), the air current 34 in the air passage 41 flows in a direction along the inner wall 36a and the outer wall 36b between the porthole 42a in the inner wall 36a and the porthole 42b in the outer wall 36b of the access door 36. Thus, an air curtain is formed in the porthole 42 and air is not likely to be exchanged between the inside and the outside of the hood 33 through the porthole 42 because of this air curtain. As a result, the suitable environment in the hood 33 is not likely to be disturbed by air outside the hood 33 and the suitable environment in the hood 33 is maintained.

Therefore, in the incubator 31 according to the embodiment, in both of states in which the door 44 closes and opens the porthole 42, the suitable environment in the hood 33 is invariably maintained. In the incubator 31 according to the above embodiment, as described above, when the porthole 42 is closed with the door 44, the protruding portion 47a of the packing 47 is in contact with the outer face of the inner wall 36a of the access door 36 to maintain airtightness between the air passage 41 and the inside of the hood 33 at the porthole 42. However, it is essential only that the packing 47 can substantially prevent the air current 34 flowing through the air passage 41 from entering the hood 33 through the porthole 42a in the inner wall 36a of the access door 36. Therefore, the protruding portion 47a of the packing 47 may merely be close to the outer face of the inner wall 36a of the access door 36 and need not be in contact with the outer face, for example.

In the incubator 31 according to the above embodiment, as described above, the door 44 turns about the rotational shaft 45 to thereby open and close the porthole 42 and the packing 47 is mounted to the door 44. Therefore, in spite of the simple structure, the packing 47 separates from and approaches the porthole 42 as the door 44 opens and closes the porthole 42.

However, it is essential only that the air current 34 is prevented from entering the hood 33 through the porthole 42a in the inner wall 36a of the access door 36 when the porthole 42 is closed by the door 44 and that the packing 47 is positioned away from the porthole 42a in the inner wall 36a of the access door 36 when the porthole 42 is opened by the door 44. Therefore, other mechanisms may be used if the packing 47 prevents the air current 34 from entering the hood 33 through the porthole 42a in the inner wall 36a of the access door 36 and separates from the porthole 42a in the inner wall 36a of the access door 36 in synchronization with closing and opening of the porthole 42 by the door 44, for example, with such mechanisms.

The present invention can be utilized for the incubator for accommodating an immature infant or the like in the hood to protect and nurse the accommodated infant.

What is claimed is:

1. An incubator comprising:
a double-wall which is at least a part of a hood for accommodating an accommodated infant and which includes an inner wall and an outer wall;
a porthole passing through the double-wall;
a door for opening and closing the porthole;
a fan for forming an air current along the inner wall and the outer wall between the inner wall and the outer wall; and
a packing which prevents the air current from entering the hood through the porthole in the inner wall in the closed state and which is positioned away from the porthole in the inner wall in the opened state.

2. An incubator according to claim 1, wherein the packing is mounted to the door and separates from and approaches the porthole in the inner wall as the porthole is opened and closed.

3. An incubator according to claim 2, wherein two-step protruding portions are formed at an outer peripheral portion of the packing and the two-step protruding portions separate from and approach the portholes in the inner wall and the outer wall, respectively, as the porthole is opened and closed.
